(19) United States
(12) Patent Application Publication
(10) Pub. No.: US 2019/0328499 A1
(43) Pub. Date: Oct. 31, 2019

(54) Novel Adhesive Paw Film Remover

(71) Applicant: Allan Cornell, Phoenix, AZ (US)

(72) Inventor: Allan Cornell, Phoenix, AZ (US)

(21) Appl. No.: 16/391,803

(22) Filed: Apr. 23, 2019

Related U.S. Application Data
(60) Provisional application No. 62/663,583, filed on Apr. 27, 2018.

(51) Int. Cl. A61D 1/00; C09J 7/38

(52) U.S. Cl. CPC A61D 1/00; C09J 7/38

(57) ABSTRACT

A novel apparatus to remove a foreign object embedded in an animal's paw is disclosed herein. In a general embodiment, the apparatus has an adhesive base that attaches to the animal's paw. When the animal steps on the apparatus with its paw, the adhesive base gently and painlessly extracts the foreign object from the animal's paw. The adhesive base is separated from the paw with the foreign objects adhere to the adhesive base.

### CROSS-REFERENCE TO RELATED APPLICATION

This application claims the benefit of priority of U.S. Provisional Patent Application No. 62/663,583, filed Apr. 27, 2018, which is hereby incorporated by reference herein in its entirety.

### TECHNICAL FIELD

This disclosure relates to the field of adhesive paw films used to remove foreign objects lodged in the soft tissue of an animal.

### BACKGROUND

Generally, when a foreign object is lodged inside soft tissue of an animal, for example, it is considered a splinter. The splinter causes a painful irritation making walking or any kind of pressure to the afflicted area painful.

Commonly, splinters are removed with tweezers or a sharp object such as a needle. Mechanical tools such as tweezers and needles (U.S. Pat. No. 2,451,994) can make removal of the foreign object painful. Other methods of removal include by chemical means whereby an ointment containing salicylic acid have been used to cause a peeling of the skin and dissemination of the thorn (EP0376986 A1). However, these devices and methods are bulky and challenging to use and may cause unnecessary pain to the animal.

Therefore, there is a need for a simple apparatus that gently removes any foreign objects embedded in the soft tissue of an animal's paw without harming the animal. An object of an embodiment of this disclosure is to provide a painless and effective apparatus and method of removing splinters from an animal's paw.

### SUMMARY

A general embodiment of the present disclosure is directed to an apparatus comprising a base and an adhesive base configured to remove foreign objects embedded in an animal's paw, especially in the thick, fatty tissue between the paw's pads. For example, the adhesive base attaches to the animal's paw and extracts any foreign obstructions, especially the ones located at between the pads of the paw.

In an embodiment, the apparatus comprises an adhesive base that aids in the painless removal of the foreign object from the fleshy portion of an animal's paw. A foreign object is anything that can be embedded in the animal's paw, including splinters, spines, slivers, thorns, burrs, leaves, sharp material, etc.

When the adhesive base is fixed to the fatty tissue of the animal's paw, it creates a sensation causing the animal to use their weight and natural gait to work out the foreign object. Once the foreign object is painlessly worked out of the thick, fatty tissue, the adhesive base may be removed and discarded. The animals do not suffer when the adhesive base is used to remove the foreign object. Embodiments of the disclosure can remove the foreign objects located anywhere on the animal paw, including the tissue between the pads.

Alternative embodiments of the present disclosure are disposable and pocket size, which allows for easy transportation of the apparatus.

### BRIEF DESCRIPTION OF THE DRAWINGS

The embodiments of the disclosure will be better understood from a reading of the following description taken in conjunction with the drawings in which like reference designators are used to designate like elements, and in which:

FIG. 1 illustrates a front perspective view of the apparatus in one embodiment; and

FIG. 2 shows a front perspective view of the apparatus comprising the adhesive base with the non-adhesive cover scrolled to the top of the adhesive base.

### DESCRIPTION

Embodiments of the present disclosure are directed to a splinter or foreign object removing apparatus comprising an adhesive base. Specifically, embodiments of the present disclosure assist in the removal of foreign objects embedded in the soft tissue of an animal's paw pad, generally referred to as a splinter, spine, sliver, thorn and/or burr.

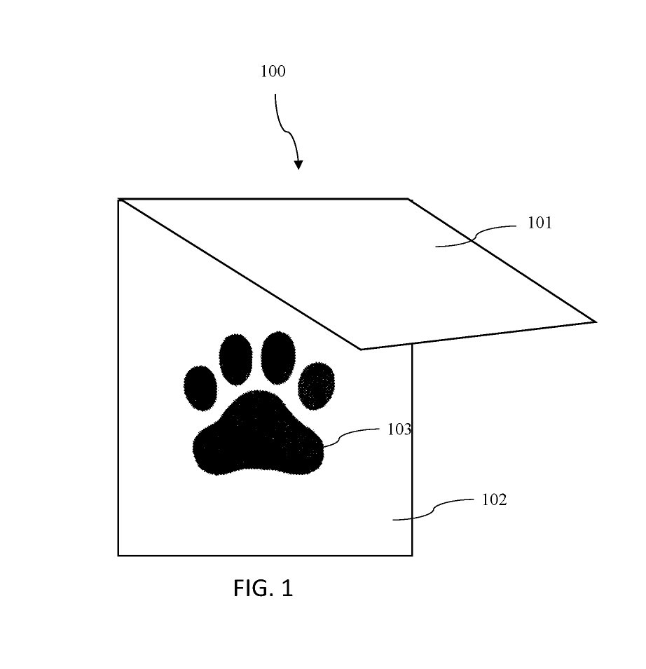

In an embodiment shown in FIG. 1A, a foreign object removing apparatus 100 comprises an adhesive base 102 having an adhesive and attached to a cover 101 removably attached to the adhesive base 102 that covers the adhesive base 102. Preferably, the cover should cover the entire adhesive base. In an embodiment, the adhesive base 102 has a target 103 in the center that acts as a target for connecting the adhesive base 102 to the animal's paw.

The adhesive can be any suitably formulated adhesive that is sticky enough to withdraw a splinter from an animal paw. For example, the adhesive can comprise of glue, spray, cyanoacrylate, polymers, or other pressure sensitive adhesives. The adhesive can comprise any suitable adhesion strength sufficient enough to contact the foreign object in the animal paw and remain in contact with the object while the object is withdrawn. The adhesive can cover any portion of the top surface area of the adhesive base 102, for example, greater than 50%, 60%, 70%, 80%, 90%, or 100% of the top surface of the adhesive base 102.

Ideally, the target 103 is where the animal's weight should be applied to optimize the efficiency of the foreign object removing apparatus 100. When the animal puts any weight on the paw, the adhesive base 102 painlessly dislodges or pulls out any foreign object embedded in the animal's paw. As a result, the apparatus 100 satisfies the needs of easily removing foreign objects from an animal's paw, especially from the space between the paws' pads.

The target can be any suitable shape or pattern and should be suited for attracting and/or allowing a pet owner or the animal to locate the target for positioning the animal's paw. For example, the target can be in the pattern of a paw print, a photo, food, or any other shape or figure. The target can be personalized to the owner's preference. The target can be 3-dimensionaly and be raised from its adhesive base. The target can also contain a scent to attract an animal.

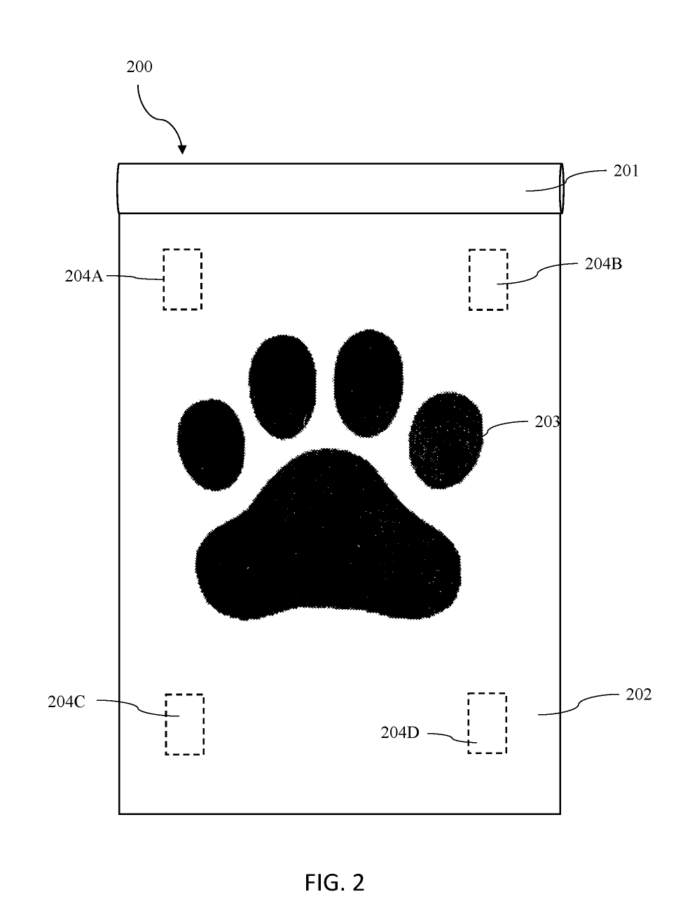

In another embodiment shown in FIG. 2, a foreign object removing apparatus 200 comprises an adhesive base 202 removably attached to a cover 201 removably attached to the adhesive base 202. The cover 201 can be scrolled to the top of the adhesive base 202 to expose the adhesive and target 203. In this embodiment, the adhesive base 202 has one or more positioning devices 204A-D integrated with the adhesive base 202 to hold the apparatus more firmly at a designated location and prevent the apparatus 200 from blowing away or moving easily.

The positioning devices 204A-D can be any suitable mechanisms attaching or connecting to another surface (e.g., floor, wall, furniture, etc . . . ) for preventing the apparatus 200 from being easily moved. For example, the positioning devices 204A-D can be weights located in or more corners of the apparatus 200 or at any suitable location of the apparatus 200. Alternatively, the positioning device can comprise one or more fasteners, clips, velcro, magnet, or another adhesive component positioned on the bottom or side of the apparatus 200 to allow the apparatus 200 to be firmly attached or connected to a floor, wall, or other stationery apparatus.

In yet another embodiment, the present disclosure provides a method of removing a splinter from an animal's paw. The method comprises providing an apparatus comprising 1) an adhesive base having and adhesive and a target on the adhesive base, and 2) a cover removably attached to the adhesive base. The removable cover is removed thereby exposing an adhesive surface of the adhesive base. The animal's paw containing a splinter is placed onto the target of the adhesive base by the animal itself or with assistance from its owners, for example. Finally, the animal's paw is manually separated from the adhesive base, wherein adhesive base attaches to the splinter in the animal's paw and pulls out the splinter from the animal's paw.

While the present disclosure is susceptible to embodiments in many different forms, there is shown in the drawings and herein described in detail, features, structures, or characteristics of the present disclosure as demonstrated in various preferred embodiments. These embodiments are to be considered for illustrative purposes and as an exemplification of the principles of the present disclosure and are not intended to limit the broad aspects of the present disclosure to the specific embodiments illustrated herein. The features, structures, or characteristics of the present disclosure as disclosed in any one preferred embodiment, for example, may be rearranged or combined with the features, structures or characteristics in any other embodiment.

One skilled in the relevant art will also recognize that the present disclosure may be practiced without one or more of the specific details, or with other methods, components, materials, and so forth. In other instances, well-known structures, materials, or operations are not shown or described in detail to avoid obscuring aspects of the disclosure. While the preferred embodiments of the present disclosure have been illustrated in detail, it should be apparent that additional modifications and adaptations to those embodiments may occur to one skilled in the art without departing from the scope of the present disclosure.

What is claimed is:

1. An apparatus for removing foreign objects from an animal's paw comprising:
an adhesive base comprising an adhesive; means for positioning said animal's paw on said adhesive base; and
a cover removably attached to the adhesive base.

2. The apparatus of claim 1, wherein the position device comprises one or more weights integrated with the corners of the adhesive base.

3. The apparatus of claim 1, wherein the position device comprises one or more fasteners, clips, velcro, magnet, or adhesive components integrated with the adhesive base.

4. The apparatus of claim 1, wherein the adhesive covers at least 50% of a top of the adhesive base.

5. A foreign object removing apparatus comprising:
an adhesive base comprising an adhesive and a target on the adhesive base; and
a non-adhesive cover removably attached to the adhesive base.

6. The apparatus of claim 5, wherein target is in the shape of a paw print.

7. The apparatus of claim 6, wherein the adhesive base comprises at least positioning device.

8. The apparatus of claim 7, wherein the position device comprises one or more weights integrated with the corners of the adhesive base.

9. The apparatus of claim 7, wherein the position device comprises one or more fasteners, clips, velcro, magnet, or adhesive components integrated with the adhesive base.

10. The apparatus of claim 5, wherein the adhesive covers at least 50% of a top of the adhesive base.

11. A method of removing a splinter from an animal's paw, the method comprising:
providing an apparatus comprising 1) an adhesive base having and adhesive and a target on the adhesive base, and 2) a cover removably attached to the adhesive base;
removing the removable cover thereby exposing an adhesive surface of the adhesive base;
placing an animal's paw containing a splinter onto the target of the adhesive base;
separating the animal's paw from the adhesive base, wherein adhesive base attaches to the splinter in the animal's paw and pulls out the splinter from the animal's paw.

12. The method of claim 11, wherein target is in the shape of a paw print.

13. The method of claim 11, wherein the adhesive base comprises at least positioning device.

14. The method of claim 13, wherein the position device comprises one or more weights integrated with the corners of the adhesive base.

15. The method of claim 13, wherein the position device comprises one or more fasteners, clips, velcro, magnet, or adhesive components integrated with the adhesive base.

16. The method of claim 11, wherein the adhesive covers at least 50% of a top of the adhesive base.
